(19) United States
(12) Patent Application Publication
(10) Pub. No.: US 2008/0056966 A1
(43) Pub. Date: Mar. 6, 2008

(54) Exhaust treatment device having a securement feature and method of assembling the exhaust treatment device

(76) Inventor: Robert A. Sarsfield, Grand Blanc, MI (US)

Correspondence Address: DELPHI TECHNOLOGIES, INC., M/C 480-410-202, PO BOX 5052, TROY, MI, 48007, US

(21) Appl. No.: 11/515,606

(22) Filed: Sep. 5, 2006

(51) Int. Cl. F01N 3/28; B01D 53/88

(52) U.S. Cl. 422/177; 422/168; 422/179; 422/180

(57) ABSTRACT

An end cone for an exhaust treatment device in accordance with an exemplary embodiment is provided. The end cone includes an outer wall and an inner cone. The inner wall is secured to the outer wall at one end. The inner wall includes at least one securement feature at another end. The at least one securement feature is configured to bias a portion of the inner wall away from the outer wall when a housing is fixedly coupled to the outer wall. The inner wall is configured to maintain the at least one securement feature in contact with the housing.

### TECHNICAL FIELD

The present invention relates to an exhaust treatment device having an end cone with a securement feature and a method of assembling the exhaust treatment device.

### BACKGROUND

Catalytic converters often utilize an end cone as a portion of their construction. The end cone aids in routing high temperature exhaust gases from a vehicle engine into the catalytic converter. Components of the exhaust gases are filtered by a catalyst within the catalytic converter. The catalyst performs best if the exhaust gases have an elevated temperature during contact with the catalyst, and therefore catalytic converters generally also utilize insulation for maintaining the exhaust gases at the elevated temperature within the catalytic converter. The end cone and the catalytic converter further experience deflection from vibration loads during operation of the vehicle and from thermal expansion caused by the hot exhaust gases.

In one configuration, the end cone is a double-wall construction having an inner wall spaced apart from an outer wall. A disadvantage with this configuration is that excessive deflection of the inner wall can result in excessive contact between the inner wall and insulation disposed between the inner and outer walls thereby degrading the insulation over time. As the insulation degrades, the insulation may not maintain the elevated temperature within the catalytic converter and therefore the catalyst's ability to filter components from the exhaust gases can also be degraded. Additionally, excessive deflection of the inner wall can also result in degradation of the catalyst due to contact between the inner wall and the catalyst.

Accordingly, it is desirable to provide an end cone for an exhaust treatment device, wherein the end cone is configured so deflection of an inner wall of the end cone is reduced during operation of the exhaust treatment device.

### SUMMARY OF THE INVENTION

An end cone for an exhaust treatment device in accordance with an exemplary embodiment is provided. The end cone includes an outer wall and an inner cone. The inner wall is secured to the outer wall at one end. The inner wall includes at least one securement feature at another end. The at least one securement feature is configured to bias a portion of the inner wall away from the outer wall when a housing is fixedly coupled to the outer wall. The inner wall is configured to maintain the at least one securement feature in contact with the housing.

An exhaust treatment device in accordance with another exemplary embodiment is provided. The exhaust treatment device includes a housing and an end cone. The housing includes an inner surface and an outer surface. The end cone includes an inner wall and an outer wall defining an inlet aperture for routing exhaust gases into the housing. The inner wall is secured to the outer wall at one end. The inner wall includes at least one securement feature at another end. The at least one securement feature is configured to bias a portion of the inner wall away from the outer wall when the housing is fixedly coupled to the outer wall. The inner wall is configured to maintain the at least one securement feature in contact with the housing.

A method for assembling an exhaust treatment device in accordance with another exemplary embodiment is provided. The method includes disposing an end cone proximate a housing. The end cone includes an inner wall and an outer wall defining an inlet aperture for routing exhaust gases into the housing. The inner wall is secured to the outer wall at one end. The inner wall includes at least one securement feature at another end. The method further includes fixedly coupling the outer wall to an outer surface of the housing. The method further includes disposing the at least one securement feature against the inner surface of the housing such that a portion of the inner wall is biased away from the outer wall. The inner wall is configured to maintain the at least one securement feature in contact with the housing.

### BRIEF DESCRIPTION OF THE DRAWINGS

FIG. 1 is a cross sectional view of a catalytic converter having end cones in accordance with an exemplary embodiment of the present invention;

FIG. 2 illustrates a portion of a catalytic converter having an alternative construction;

FIGS. 3 and 4 illustrate computer models of the catalytic converter of FIG. 1 having first and second mounting flange configurations, respectively;

FIG. 5 is a perspective view of a computer model of one end cone utilized in the catalytic converter of FIG. 1;

FIG. 6 is a deflection plot associated with two end cones;

FIG. 7 is a deflection plot associated with two other end cones; and

FIG. 8 is a table illustrating frequencies for vibration analysis of end cones.

### DETAILED DESCRIPTION OF EXEMPLARY EMBODIMENTS

Exemplary embodiments of the present invention are directed to an end cone utilized with a vehicle exhaust treatment device. A configuration of the end cone minimizes movement of a portion of the end cone due to vibrations the end cone encounters during operation of the vehicle. Movement of portions of the end cone may also be due to thermal expansion due to hot exhaust gases flowing through the exhaust treatment device. For example and in one exemplary embodiment, the end cone is secured to a housing of a catalytic converter. The end cone is configured so at least one securement feature of the end cone is biased to contact an inner surface of the housing while another portion of the end cone is secured to the housing. The end cone is further configured so deflection of a portion of the end cone is reduced compared to an end cone without the securement feature that contacts the housing. In another exemplary embodiment, the securement feature of the end cone is configured for aligning a portion of the end cone with the housing of the catalytic converter during assembly of the end cone to the housing, thereby minimizing assembly time and reducing a manufacturing cost of the catalytic converter.

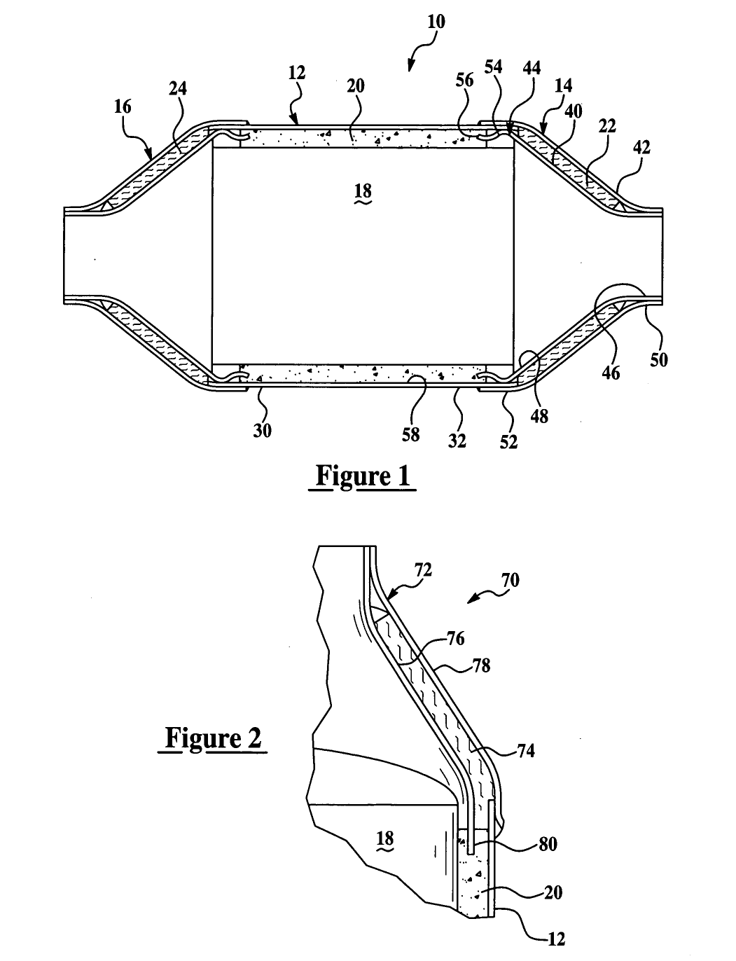

Referring to FIG. 1, an exhaust treatment device such as a catalytic converter 10 is illustrated in accordance with an exemplary embodiment of the present invention. Catalytic converter 10 is a portion of a vehicle exhaust system and is provided for filtering components of exhaust gases being routed from a vehicle engine.

Catalytic converter 10 includes a housing 12, end cones 14 and 16, a catalyst 18, a mat support 20, and insulating members 22 and 24. In one exemplary embodiment, housing 12 has a substantially tubular shape extending from end portion 30 to end portion 32 and configured for holding catalyst 18 and mat support 20 therein. End cone 14 is provided for routing exhaust gases toward catalyst 18 from an adjoining section of the vehicle exhaust system. End cone 16 is provided for routing the exhaust gases from catalytic converter 10 after the exhaust gases have flowed through catalyst 18. Catalyst 18 is provided for filtering predetermined constituents of the exhaust gases from the exhaust gas stream. Mat support 20 is provided for supporting catalyst 18 within housing 12 and providing a thermal barrier for maintaining an elevated temperature of the exhaust gases within catalyst 18 for optimized filtration of the constituents from the exhaust gases. In an exemplary embodiment of catalytic converter 10, mat support 20 is constructed from intumescent material. In an alternative embodiment, matt support 20 is constructed from a non-intumescent material. Insulating members 22, 24 are disposed between the inner and outer walls of each end cone 14, 16. The insulating members are provided to minimize heat loss of the exhaust gases within end cones 14, 16.

In one exemplary embodiment, end cone 16 is configured substantially similar to end cone 14 and therefore only end cone 14 will be discussed in detail. In an exemplary embodiment, end cone 14 includes a substantially cone shaped inner wall 40 disposed within and spaced apart from a substantially cone shaped outer wall 42. Inner wall 40 extends from an end portion 46 to an end portion 48. Outer wall 42 extends from an end portion 50 to an end portion 52. Insulating member 22 is disposed between inner wall 40 and outer wall 42. End portion 52 of outer wall 42 is secured to end portion 32 of housing 12 via any suitable attachment process. For example, end portion 52 can be secured to end portion 32 by a welding process. In one exemplary embodiment, end portion 46 of inner wall 40 is joined to end portion 50 of outer wall 42 wherein end cone 14 is secured to another tubular member of the exhaust system at the joined end portions of inner wall 40 and outer wall 42. In an alternative exemplary embodiment, a flange member (not shown) is secured to the joined end portions of inner wall 40 and outer wall 42 of end cone 14, wherein the flange member may be coupled directly to a portion of the vehicle's engine or another portion of the vehicle's exhaust system.

Inner wall 40 further includes a securement feature 44 at end portion 48, wherein inner wall 40 is configured to bias securement feature 44 against an inner surface 58 of housing 12. Securement feature 44 is configured to bias a portion of inner wall 40 away from outer wall 42 when outer wall 40 is secured to housing 12. It should be noted that is desirable to have contact between inner surface 58 of housing 12 and securement feature 44 to reduce deflection of inner wall 40 caused by the vibration of catalytic converter 10. Reducing deflection of inner wall 40 will minimize movement of inner wall 40 against insulating member 22 and therefore minimize degradation of insulating member 22.

Degradation of insulating member 22 due to contact with inner wall 40 having securement feature 44 is reduced because the vibration loads deflect inner wall 40 less distance compared to an inner wall without securement feature 44. Less erosion of insulating member 22 results in insulating member 22 maintaining the exhaust gases at the elevated temperature within end cone 14 and better performance of catalyst 18 for filtration of the exhaust gases.

In one exemplary embodiment, securement feature 44 includes at least one protrusion 54 and a flange portion 56. Protrusion 54 extends around a periphery of end cone 14 and away from an adjoining portion of inner wall 40 in a direction toward inner surface 58 of housing 12, wherein an outer surface of protrusion 54 contacts inner surface 58 of housing 12. In another exemplary embodiment, end cone 14 has four securement features spaced approximately 90° apart from each other about a periphery of inner wall 40. Each of the four securement features has a cross-sectional profile substantially similar to securement feature 44 and each of the four securement features contacts inner surface 58 of housing 12. In an exemplary embodiment, inner wall 40 may be subjected to a forming operation to form the securement feature(s). For example, the securement feature(s) may be formed by subjecting inner wall 40 to a stamping operation.

Flange portion 56 extends from securement feature 44 and is configured to be embedded into mat support 20. As a result, movement of inner wall 40 proximate end portion 48 is minimized due to flange portion 56 being embedded into mat support 20. Additionally, since securement feature 44 is biased toward inner surface 58 of housing 12, inner wall 40 is prevented from contacting and degrading catalyst 18.

Securement feature 44 can be configured and utilized for aligning end cone 14 with housing 12 during assembly of catalytic converter 10, thus saving time and manufacturing cost of catalytic converter 10. For example and during assembly of end cone 14 to housing 12, end cone 14 remains in a substantially fixed orientation with respect to housing 12 because securement feature 44 has frictional contact with inner surface 58 of housing 12. Thus, it is not necessary to manually hold or use tooling to hold end cone 14 in a fixed orientation while assembling end cone 14 to housing 12.

In another alternative exemplary embodiment, insulating member 22 extends toward another insulating layer such as mat support 20 between a plurality of securement features, thereby providing a thermal barrier between the securement features. Extending the insulating member between the securement features aids in maintaining the exhaust gases within end cone 14 at the elevated temperature, minimizing heat loss proximate the securement features, and thereby provides exhaust gases to catalyst 18 at an elevated temperature for optimum performance of catalyst 18. In another alternative embodiment, the mat support 20 can be replaced with a region of air.

Referring to FIG. 2, a portion of a catalytic converter 70 having an end cone 72, wherein end cone 72 has a different configuration compared to end cone 14 of FIG. 1. Catalytic converter 70 includes housing 12, end cone 72, catalyst 18, mat support 20 and an insulating member 74.

End cone 72 includes an inner wall 76, an outer wall 78, wherein insulating member 74 is disposed between inner wall 76 and outer wall 78. Inner wall 76 includes an end portion 80 that is embedded into mat support 20. During vehicle operation, end portion 80 moves within mat support 20 due to the vibration loads. Over time, movement of end portion 80 within mat support 20 can degrade mat support 20 proximate end portion 80. Additionally, as inner wall 76 deflects due to the vibration loads, insulating member 74 can degrade over time due to movement between inner wall 76 and insulating member 74. Moreover, as mat support 20 erodes, inner wall 76 may deflect a greater distance due to less support and therefore further degrade mat support 20 and or insulating member 74.

Additionally and depending on the amount of deflection, inner wall 76 of end cone 72 is more likely to contact catalyst 18 and degrade the performance of catalyst 18 compared to the configuration of end cone 14.

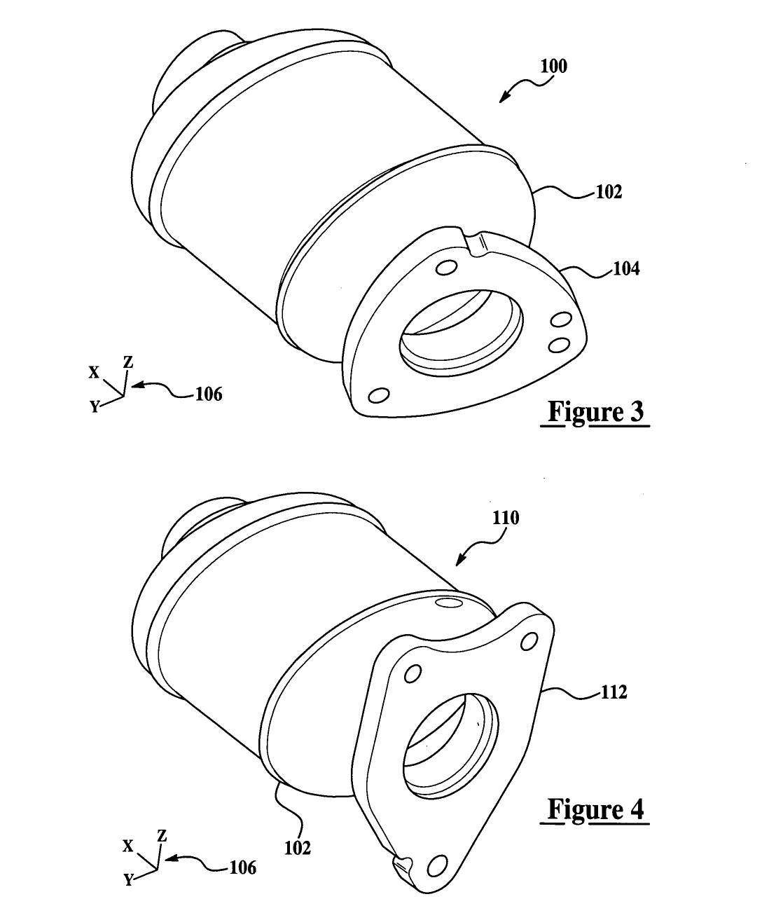

Referring to FIG. 3, a computer model 100 utilized for a vibration analysis of catalytic converter 10 with an attached flange member is shown. Computer model 100 is shown in a deflected condition due to vibration loads applied to computer model 100. Computer model 100 includes an end cone model 102 and a flange member model 104. End cone model 102 is a computer model of end cone 14 of catalytic converter 10. Flange member model 104 is a computer model of a flange member utilized to secure the catalytic converter to another portion of the exhaust system or to the vehicle's engine. Computer model 100 is oriented with respect to a Cartesian coordinate system 106 wherein an x-axis extends along a longitudinal direction of computer model 100 and a y-axis and a z-axis form a plane extending through a cross section of computer model 100.

Referring to FIG. 4, a computer model 110 of another configuration of a catalytic converter having a flange member is shown. Computer model 110 includes end cone model 102 and a flange member model 112 to simulate a different mounting configuration as compared to flange member model 104 of computer model 100.

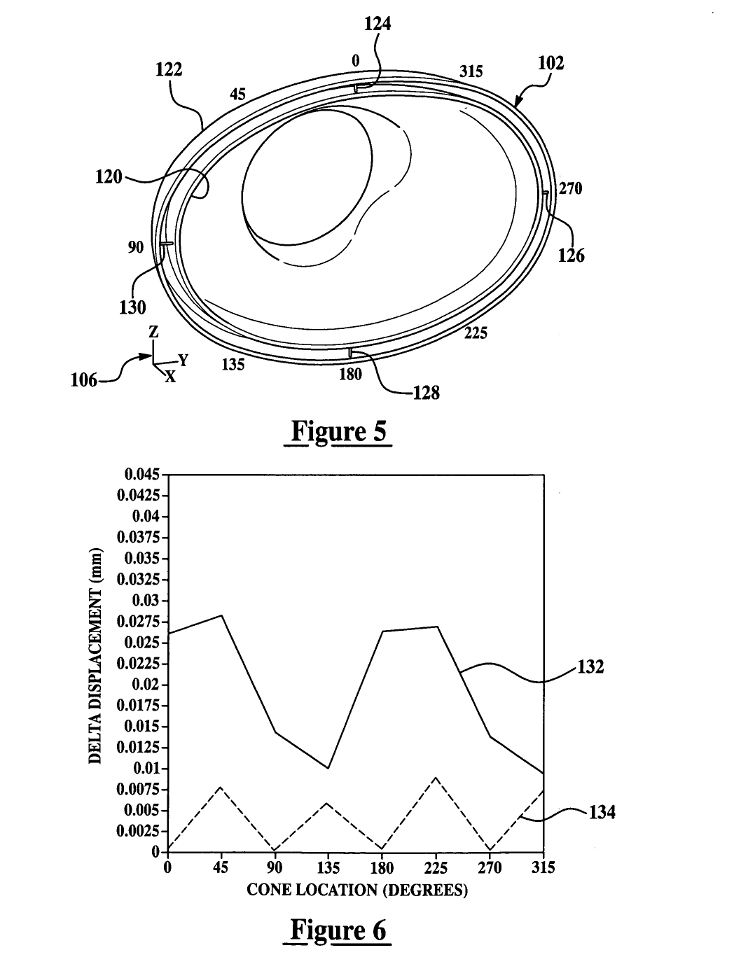

FIG. 5 illustrates a computer model of end cone model 102 utilized in computer models 100, 110. End cone model 102 includes an inner wall 120, an outer wall 122, and four link members 124, 126, 128 and 130. Link members 124, 126, 128 and 130 simulate securement features spaced 90° apart about a periphery of end cone model 102 between inner wall 120 and outer wall 122.

FIG. 6 illustrates a displacement curve 132, generated utilizing a computer model (not shown) substantially similar to computer model 100 having a computer model of end cone 72 instead of end cone model 102. Displacement curve 132 represents displacement of inner wall 76 with respect to outer wall 78 of end cone 72. FIG. 6 further illustrates a displacement curve 134 of inner wall 120 with respect to outer wall 122 of end cone model 102.

FIG. 7 illustrates a displacement curve 136, generated utilizing a computer model (not shown) substantially similar to computer model 110 having a computer model of end cone 72 instead of end cone model 102. Displacement curve 136 represents displacement of inner wall 76 with respect to outer wall 78 of end cone 72. FIG. 7 further illustrates a displacement curve 138 of inner wall 120 with respect to outer wall 122 of end cone model 102.

As illustrated, the displacements of inner wall 120 of end cone 102 are substantially less than those of inner wall 76 of end cone 72. Additionally, the deflections of inner wall 120 of end cone 102 are much more uniform around a periphery of inner wall 120 compared to inner wall 76 of end cone 72. Thus, since the inner wall having the securement feature does not deflect as much as an inner wall without the securement feature, the inner wall having the securement feature will also not wear or erode the insulating member between the inner and outer wall of the end cone as much as the inner wall without the securement feature.

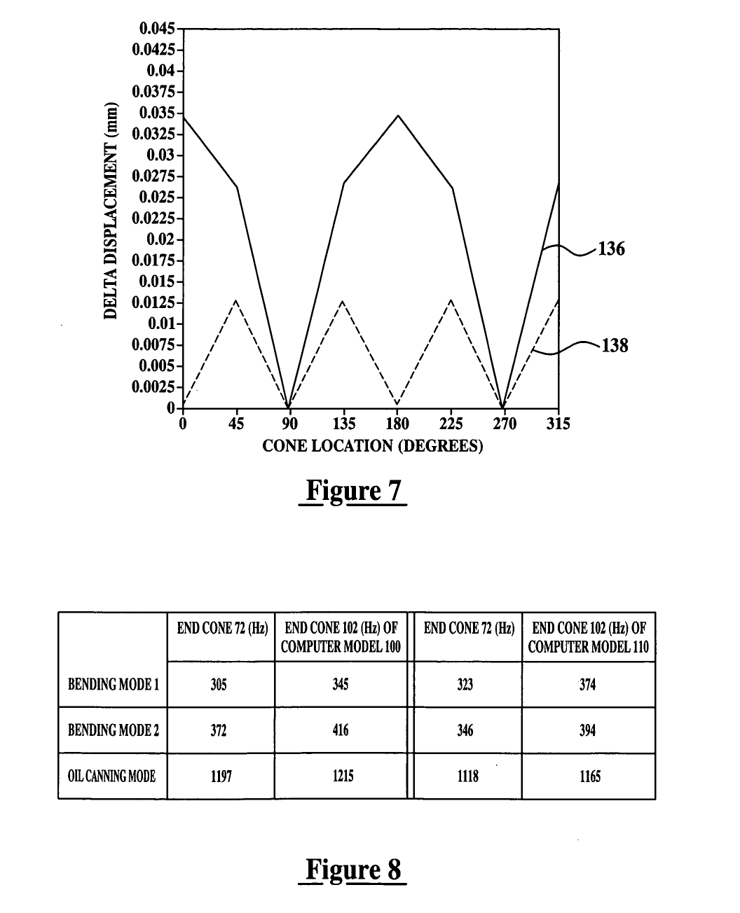

Additionally, the displacement curves shown in FIGS. 6 and 7 are for a bending mode 1 discussed later herein with respect to FIG. 8. Displacements of bending mode 1 are selected for examination because that deflection mode generally has the largest values of displacements.

FIG. 8 illustrates a table of excitation frequencies for vibrations associated with the vibration analysis of computer models 100, 110 of FIGS. 3 and 4, respectively. An excitation frequency is a measure of energy that displaces the end cone at a resonant frequency of the end cone. As illustrated, excitation frequencies associated with deflections of end cone model 102 are greater compared to excitation frequencies associated with deflections of a computer model of end cone 72. Thus greater energy is necessary to displace end cone model 102 compared to a computer model of end cone 72 because inner wall 120 of end cone model 102 includes securement features (link members 124, 126, 128 and 130) that are biased to contact inner surface 58 of housing 12. The excitation frequencies of computer models 100, 110 are output for bending mode 1, a bending mode 2, and an oil-canning mode. These modes were selected because these modes are likely to be encountered by catalytic converter 10 during operation of the vehicle.

Bending mode 1 represents a deflected shape of the inner wall of the end cone at a first frequency wherein two portions of the end cone about 180° apart simultaneously deflect from their undeflected position. Bending mode 2 represents a deflected shape of the inner wall of the end cone at a second frequency wherein four portions of the end cone about 90° apart simultaneously deflect from their undeflected position. For example and in bending modes 1 or 2, the portions of the end cone may deflect in a cyclic manner wherein the inner wall and outer wall move toward each other and then move away from each other.

The oil-canning mode represents a deflected shape of the end cone wherein a circumferential portion of the inner wall and outer wall move toward one another substantially at the same time and then move away from each other in a manner that closes and opens a circumferential space between the inner and outer walls of the end cone.

The exemplary embodiments disclosed herein provide for a catalytic converter having a double-wall end cone construction wherein an inner wall of the end cone is configured to bias a securement feature of the inner wall against an inner surface of a housing of the catalytic converter. The configuration results in less deflection of the inner wall of the end cone and reduces erosion of insulating members used with the catalytic converter, thus also optimizing performance of the catalytic converter by maintaining exhaust gases in the catalytic converter at an elevated temperature.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the present application

What is claimed is:

1. An end cone for an exhaust treatment device, comprising:
an outer wall; and
an inner wall secured to the outer wall at one end and further comprising at least one securement feature at another end, the at least one securement feature being configured to bias a portion of the inner wall away from the outer wall when a housing is fixedly coupled to the outer wall, the inner wall being configured to maintain the at least one securement feature in contact with the housing.

2. The end cone of claim 1, wherein the at least one securement feature comprises an arcuate shaped portion and a flange portion.

3. The end cone of claim 1, wherein the at least one securement feature comprises a plurality of securement features spaced about a periphery of the other end.

4. The end cone of claim 1, further comprising an insulating layer disposed between the inner wall and the outer wall.

5. An exhaust treatment device, comprising:
a housing having an inner surface and an outer surface; and
an end cone having an inner wall and an outer wall defining an inlet aperture for routing exhaust gases into the housing, the inner wall secured to the outer wall at one end and further comprising at least one securement feature at another end, the at least one securement feature being configured to bias a portion of the inner wall away from the outer wall when the housing is fixedly coupled to the outer wall, the inner wall being configured to maintain the at least one securement feature in contact with the housing.

6. The exhaust treatment device of claim 5, wherein the at least one securement feature comprises an arcuate shaped portion and a flange portion.

7. The exhaust treatment device of claim 6, further comprising an insulating layer disposed on the inner surface of the housing.

8. The exhaust treatment device of claim 7, wherein the flange portion of the securement feature extends into the insulating layer.

9. The exhaust treatment device of claim 5, wherein the at least one securement feature comprises a plurality of securement features spaced about a periphery of the other end.

10. The exhaust treatment device of claim 5, further comprising an insulating layer disposed between the inner wall and the outer wall.

11. The exhaust treatment device of claim 5, further comprising a catalyst member disposed in the housing, the catalyst member configured to remove undesirable exhaust gas constituents from received exhaust gases.

12. A method for assembling an exhaust treatment device, comprising:
disposing an end cone proximate a housing, the end cone having an inner wall and an outer wall defining an inlet aperture for routing exhaust gases into the housing, the inner wall secured to the outer wall at one end and further comprising at least one securement feature at another end;
fixedly coupling the outer wall to an outer surface of the housing; and
disposing the at least one securement feature against the inner surface of the housing such that a portion of the inner wall is biased away from the outer wall, the inner wall being configured to maintain the at least one securement feature in contact with the housing.

13. The method of claim 12, further comprising disposing an insulating layer between the inner wall and the outer wall.

14. The method of claim 12, further comprising disposing an insulating layer on the inner surface of the housing.

15. The method of claim 12, further comprising disposing a catalyst member in the housing, the catalyst member configured to remove undesirable exhaust gas constituents from received exhaust gases.
